(19) United States
(12) Patent Application Publication
(10) Pub. No.: US 2012/0263397 A1
(43) Pub. Date: Oct. 18, 2012

(54) IMAGE PROCESSING DEVICE, IMAGE PROCESSING METHOD, AND PROGRAM

(75) Inventor: Atsushi Kimura, Tokyo (JP)

(73) Assignee: Sony Corporation, Tokyo (JP)

(21) Appl. No.: 13/406,033

(22) Filed: Feb. 27, 2012

(30) Foreign Application Priority Data
Apr. 12, 2011 (JP) 2011-087893

(51) Int. Cl. G06K 9/36

(52) U.S. Cl. 382/284

(57) ABSTRACT

There is provided an image processing device including a subject information detecting section for detecting subject information on frame image data in an input process of a series of n frame image data used to generate a panoramic image; and a seam determination processing section for sequentially carrying out, in the input process, a process of obtaining a position of each of m joints to become a joint between adjacent frame image data through an optimum position determination process using the subject information detected by the subject information detecting section for every (m+1) (m<n) frame image data group and determining m or less joints.

### BACKGROUND

The present disclosure relates to an image processing device and an image processing method for generating a panoramic image, and a program for realizing the same.

As described in Japanese Patent Application Laid-Open No. 2010-161520, image processing for generating one panoramic image from a plurality of images is known.

In the process of synthesizing a plurality of imaged images (plurality of frame image data) to generate a panoramic image, if a moving subject exists in an imaged scene, this becomes a cause of image crash or degraded image quality, for example, a part of the moving subject being divided or blurred.

Thus, a method of detecting the moving subject and determining a joint (seam) for forming the panoramic image while avoiding the moving subject has been proposed.

### SUMMARY

The following issues arise when determining the seam while avoiding a specific subject, and synthesizing each image.

In order to determine an optimum joint for the entire panoramic image, the joint is to be determined with reference to information (at least one of position, pixel, moving subject, face detection, etc.) of all image frames to synthesize. Thus, the process of determining the joint will not start until the processes (imaging, aligning, various detection processes, etc.) on all the image frames are finished.

This means that all the information including the pixel information of all the images are to be saved until the process on the final imaged image is completed in a system for carrying out a panoramic synthesis.

The amount of data of the imaged image is from a few times to a few dozen times the amount of data of the final panoramic image since a great number of still images having a wide range of overlapping regions is generally synthesized in the panoramic synthesis.

Therefore, this may become a factor in degrading the image quality of the panorama image or triggering the narrowing of the panoramic field angle in an incorporating device having a strict restriction on the memory capacity, in particular.

The generation of the panoramic image may not be realized in some cases unless countermeasure such as lowering the resolution of the imaged image or reducing the number of imaged images is taken, for example, and it is difficult to generate a panoramic image of high resolution, high image quality and wide field angle.

Since the determination of the seam does not start until the imaging of all the images is finished, the panorama synthesizing time is increased at the same time.

In view of such issues, it is desirable to realize the process of carrying out the synthesis at the joint avoiding the moving subject with a low memory capacity and a short processing time in the generation of the panoramic image.

According to the present disclosure, there is provided an image processing device including a subject information detecting section for detecting subject information for frame image data in an input process of a series of n frame image data used to generate a panoramic image, and a seam determination processing section for sequentially carrying out, in the input process, a process of obtaining a position of each of m joints to become a joint between adjacent frame image data through an optimum position determination process using the subject information detected by the subject information detecting section for every (m+1) (m<n) frame image data group and determining m or less joints.

Further it may include an image synthesizing section for generating panoramic image data using the n frame image data by synthesizing each frame image data based on the joint determined by the seam determination processing section.

According to the present disclosure, there is provided an image processing method including sequentially carrying out, in an input process of a series of n (m<n) frame image data used to generate a panoramic image, detecting subject information for frame image data, and obtaining a position of each of m joints to become a joint between adjacent frame image data through an optimum position determination process using the subject information detected by a subject information detecting section for every (m+1) frame image data group and determining m or less joints.

According to the present disclosure, there is provided a program for causing a calculation processing unit to sequentially execute, in an input process of a series of n (m<n) frame image data used to generate a panoramic image, processes of detecting subject information for frame image data, and obtaining a position of each of m joints to become a joint between adjacent frame image data through an optimum position determination process using the subject information detected by a subject information detecting section for every (m+1) frame image data group and determining m or less joints.

According to the embodiments of the present disclosure described above, when generating a panoramic image by synthesizing n frame image data, a joint (seam) is sequentially determined in the input process of such n frame image data. In other words, an optimum joint position is comprehensively obtained for m seams between the adjacent images of the (m+1) frame image data for every (m+1) frame image data group. Then, m or fewer joints (at least one or more joints) are determined This process is repeatedly carried out in the input process of the frame image data to determine each seam.

Accordingly, the seam determination process can proceed before the input of all n frame image data is completed. Furthermore, the image capacity to store can be reduced since the image portion not used for the panorama synthesis is already determined in the frame image data in which the seam is determined.

Furthermore, the seam determination, which takes into consideration the entire plurality of frame image data, can be carried out by obtaining each seam with the (m+1) frame image data group.

According to the embodiments of the present disclosure, the process of carrying out the synthesis at the joint avoiding the moving subject can be realized with a low memory capacity and a short processing time in the generation of the panoramic image. Since the optimum seam is obtained in view of the entire plurality of frame image data in the (m+1) frame image data group, the determined seam becomes a more appropriate position.

### BRIEF DESCRIPTION OF THE DRAWINGS

FIG. 1 is a block diagram of an imaging device according to an embodiment of a present disclosure;

FIG. 2 is an explanatory view of an image group obtained in panorama imaging;

FIG. 3 is an explanatory view of a seam in frame image data of the panorama imaging;

FIG. 4 is an explanatory view of a panoramic image;

FIG. 5 is an explanatory view of a panorama synthesizing process of the embodiment;

FIG. 6 is an explanatory view of a cost function of the embodiment;

FIG. 7 is an explanatory view in which a spatial condition is reflected on the cost function of the embodiment;

FIG. 8 is an explanatory view of a relationship of the cost function between the frames of the embodiment;

FIG. 9 is a flowchart of a panorama synthesizing process example I of the embodiment;

FIG. 10 is an explanatory view of a blend process of before and after the seam of the embodiment;

FIG. 11 is an explanatory view of a seam determination in an input process of the embodiment;

FIG. 12 is an explanatory view of a region to save after the seam determination of the embodiment;

FIG. 13 is an explanatory view of a joint setting range corresponding to a frame order of the embodiment;

FIG. 14A is a flowchart of a panorama synthesizing process example II of the embodiment;

FIG. 14B is a flowchart of a panorama synthesizing process example II of the embodiment; and

FIG. 15 is a flowchart of a panorama synthesizing process example III of the embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

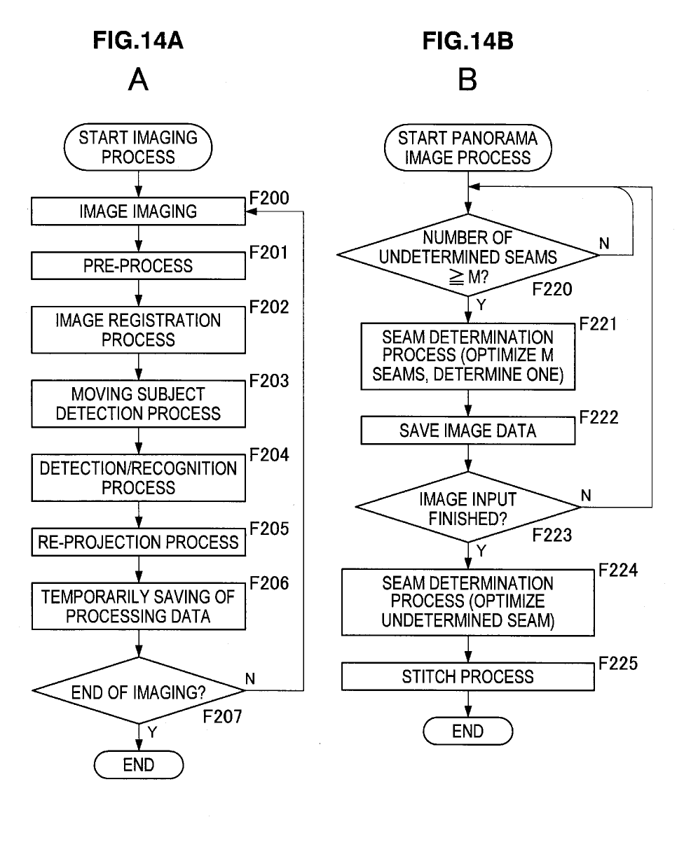

The embodiments will be hereinafter described in the following order. In the present document, FIG. 14A and FIG. 14B are sometimes simply indicated as FIG. 14, and are indicated with the notations A, B when distinguishing them. In the embodiment, an imaging device mounted with an image processing device of the present disclosure will be described by way of example.

<1. Configuration of imaging device>
<2. Outline of panorama synthesizing function>
<3. Panorama synthesizing algorithm of embodiment>
<4. Panorama synthesizing process example I>
<5. Panorama synthesizing process example II>
<6. Panorama synthesizing process example III>

### <7. Program>

### <8. Variant>

### <1. Configuration of Imaging Device>

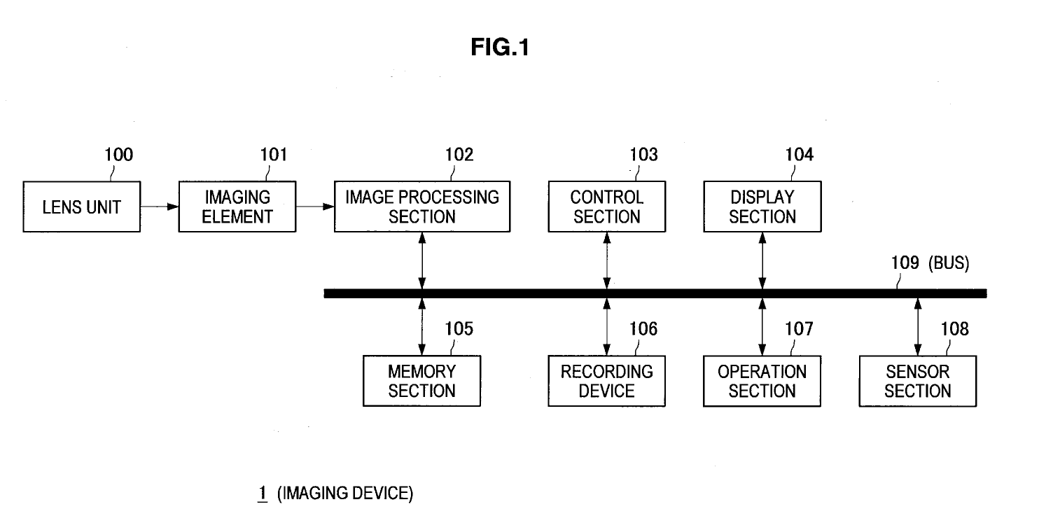

FIG. 1 shows a configuration example of an imaging device 1.

The imaging device 1 includes a lens unit 100, an imaging element 101, an image processing section 102, a control section 103, a display section 104, a memory section 105, a recording device 106, an operation section 107, and a sensor section 108.

The lens unit 100 collects a light image of a subject. The lens unit 100 has a mechanism for adjusting a focal length, a subject distance, an aperture, and the like so that an appropriate image is obtained according to an instruction from the control section 103.

The imaging element 101 photoelectrically converts the light image collected by the lens unit 100 to convert to an electrical signal. Specifically, the imaging element 101 is realized by a CCD (Charge Coupled Device) image sensor, a CMOS (Complementary Metal Oxide Semiconductor) image sensor, and the like.

The image processing section 102 includes a sampling circuit for sampling the electrical signal from the imaging element 101, an A/D converter circuit for converting an analog signal to a digital signal, an image processing circuit for performing a predetermined image processing on the digital signal, and the like. Here, the image processing section 102 is adapted to carry out the process for obtaining the frame image data by the imaging in the imaging element 101 and the process for synthesizing the panoramic image, to be described later.

The image processing section 102 includes not only a dedicated hardware circuit, but also a CPU (Central Processing Unit) and a DSP (Digital Signal Processor) to be able to perform software process to respond to flexible image processing.

The control section 103 includes a CPU and a control program, and controls each unit of the imaging device 1. The control program itself is actually stored in the memory section 105, and is executed by the CPU.

The process (panorama synthesizing processes I, II, III, etc. to be described later) for synthesizing the panoramic image of the present embodiment is executed by the control section 103 and the image processing section 102. The details on such process will be described later.

The display section 104 includes a D/A converter circuit for converting the image data processed by the image processing section 102 and stored in the memory section 105 to an analog form, a video encoder for encoding the image signal in analog form to a video signal in a form adapted to a display device in post-stage, and a display device for displaying the image corresponding to the input video signal.

The display device is realized, for example, by an LCD (Liquid Crystal Display), an organic EL (Electroluminescence) panel, and the like and also has a function serving as a finder.

The memory section 105 includes a semiconductor memory such as a DRAM (Dynamic Random Access Memory), and temporarily records the image data processed by the image processing section 102, the control program in the control section 103, and various types of data.

The recording device 106 includes a recording medium such as a semiconductor memory including a flash memory (Flash Memory), a magnetic disc, an optical disc, and a magneto-optical disc, and a recording and reproducing system circuit/mechanism with respect to these recording media.

In imaging by the imaging device 1, JPEG image data encoded to the JPEG (Joint Photographic Experts Group) form by the image processing section 102 and stored in the memory section 105 is recorded on a recording media.

In reproduction, the JPEG image data saved in the recording media is read to the memory section 105 and subjected to a decoding process by the image processing section 102. The decoded image data may be displayed in the display section 104, or may be output to an external device through an external interface (not shown).

The operation section 107 includes a hardware key such as a shutter button, an operation dial, and an input device such as a touch panel, and is adapted to detect the input operation of a photographer (user) and transmit the same to the control section 103. The control section 103 determines the operation of the imaging device 1 according to the input operation of the user, and performs a control such that each unit carries out the desired operation.

The sensor section 108 includes a gyro sensor, an acceleration sensor, a geomagnetic sensor, a GPS (Global Positioning System) sensor, and the like, and is adapted to carry out the detection of various types of information. Such information are added to the imaged image data as metadata, and furthermore, used in various image processing and control process.

The image processing section 102, the control section 103, the display section 104, the memory section 105, the recording device 106, the operation section 107, and the sensor section 108 are mutually connected through a bus 109 so that the image data, the control signal, and the like can be exchanged.

### <2. Outline of Panorama Synthesizing Function>

The outline of the panorama synthesizing function of the imaging device 1 will now be described.

The imaging device 1 of the present embodiment can generate the panoramic image by carrying out a synthesizing process with respect to a plurality of still images (frame image data) obtained when the photographer images while rotatably moving the imaging device 1 about a certain rotation axis.

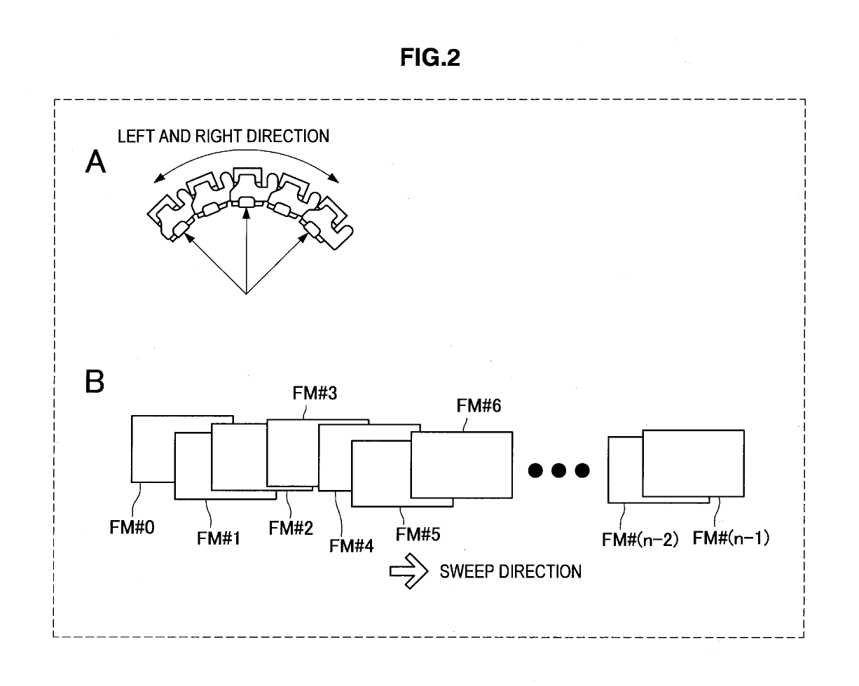

FIG. 2A shows the movement of the imaging device 1 at the time of panorama imaging. The center of rotation at the time of imaging is desirably a point unique to a lens that does not produce parallax called a nodal point since the parallax of the long distance view and the short distance view causes unnaturalness in the joint when synthesizing the panorama imaging.

The rotational movement of the imaging device 1 at the time of the panorama imaging is called the “sweep”.

FIG. 2A is a conceptual diagram of when an appropriate alignment is carried out on the plurality of still images obtained by the sweep of the imaging device 1. With each still image obtained in imaging in the temporal order of imaging, the frame image data imaged from time 0 to time (n−1) is indicated as frame image data FM#0, FM#1, . . . , FM#(n−1). When generating the panoramic image from n still images, the synthesizing process is performed on a series of n frame image data FM#0 to FM#(n−1) imaged successively, as shown in the figure.

As shown in FIG. 2A, each imaged frame image data has to have an overlapping portion with the adjacent frame image data, and hence an imaging time interval of each frame image data of the imaging device 1 and an upper limit value of a speed at which the photographer sweeps are to be appropriately set.

The frame image data group aligned in such manner has many overlapping portions, and thus a region to use for the final panoramic image is to be determined with respect to each frame image data. In other words, a joining portion (seam) of the images in the panorama synthesizing process is to be determined

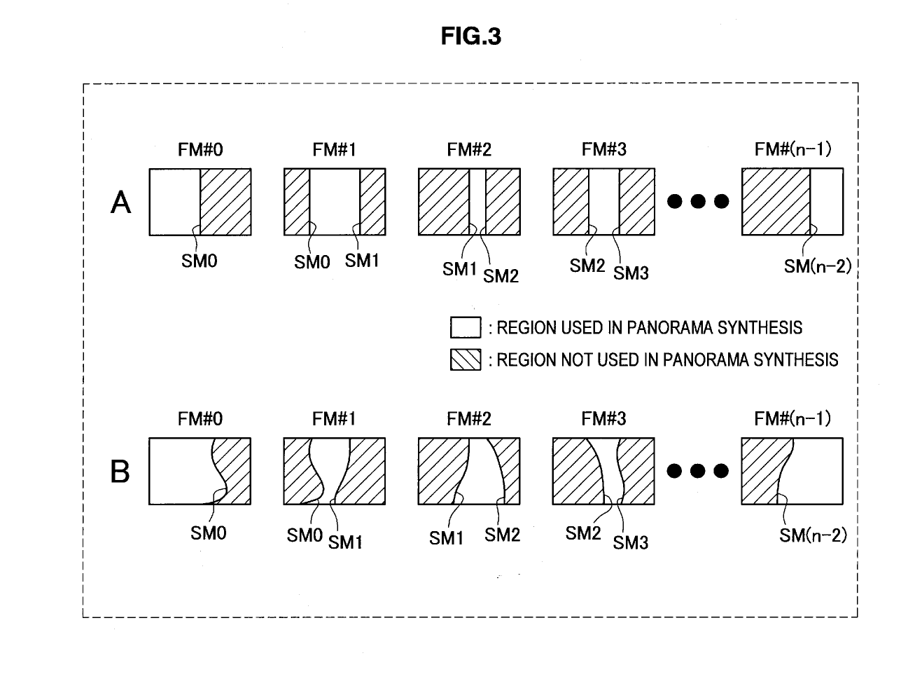

In FIG. 3A and FIG. 3B, an example of a seam SM is shown.

The seam may be a line perpendicular to a sweep direction, as shown in FIG. 3A, or may be non-linear (curve etc.), as shown in FIG. 3B.

In FIG. 3A and FIG. 3B, a seam SM0 shows the joint between the frame image data FM#0, FM#1, a seam SM1 shows the joint between the frame image data FM#1, FM#2, . . . , and a seam SM(n−2) shows the joint between the frame image data FM#(n−2), FM#(n−1).

Such seams SM0 to SM(n−2) become the joints between the adjacent images at the time of synthesis, so that the shaded portion in each frame image data becomes the image region that is not used in the final panoramic image.

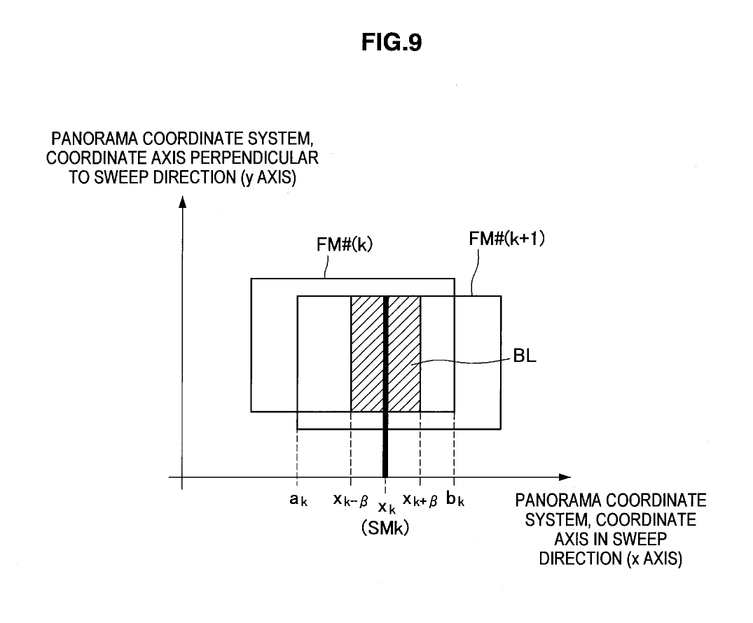

When carrying out the panorama synthesis, a blend process is sometimes carried out on the image regions before and after the seam in an aim of reducing the unnaturalness of the images around the seam. The blend process will be described later in FIG. 9.

The common portion of each frame image data may be joined by performing the blend process over a wide range, or the pixels contributing to the panoramic image may be selected for every pixel from the common portion, where the joint does not clearly exist in these cases but such wide range of joining portion is also considered the same as the seam in the present specification.

As shown in FIG. 2B, a slight movement not only in the sweep direction but also in a direction perpendicular to the sweep is generally recognized, as a result of the alignment of each frame image data. This is a shift that occurs from a hand jiggle or the like of the photographer at the time of the sweep.

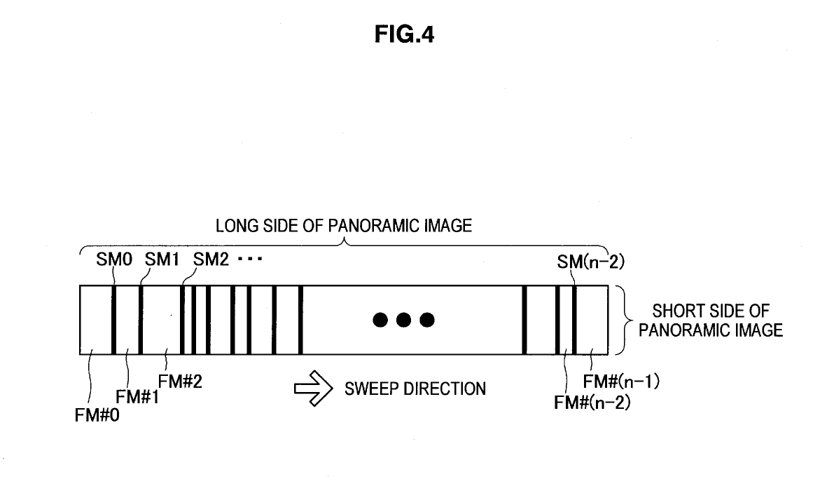

A panoramic image having a wide field angle having the sweep direction as a long side direction, as shown in FIG. 4, is obtained by determining the seam of each frame image data, joining by performing the blend process on the boundary region thereof, and finally trimming the unnecessary portion in the direction perpendicular to the sweep in view of the hand jiggle amount.

In FIG. 4, the vertical line shows the seam, where a state in which n frame image data FM#0 to FM#(n−1) are respectively joined at the seams SM0 to SM(n−2) to generate the panoramic image is schematically shown.

<3. Panorama Synthesizing Algorithm of embodiment>

The details on the panorama synthesizing process of the imaging device 1 of the present embodiment will now be described.

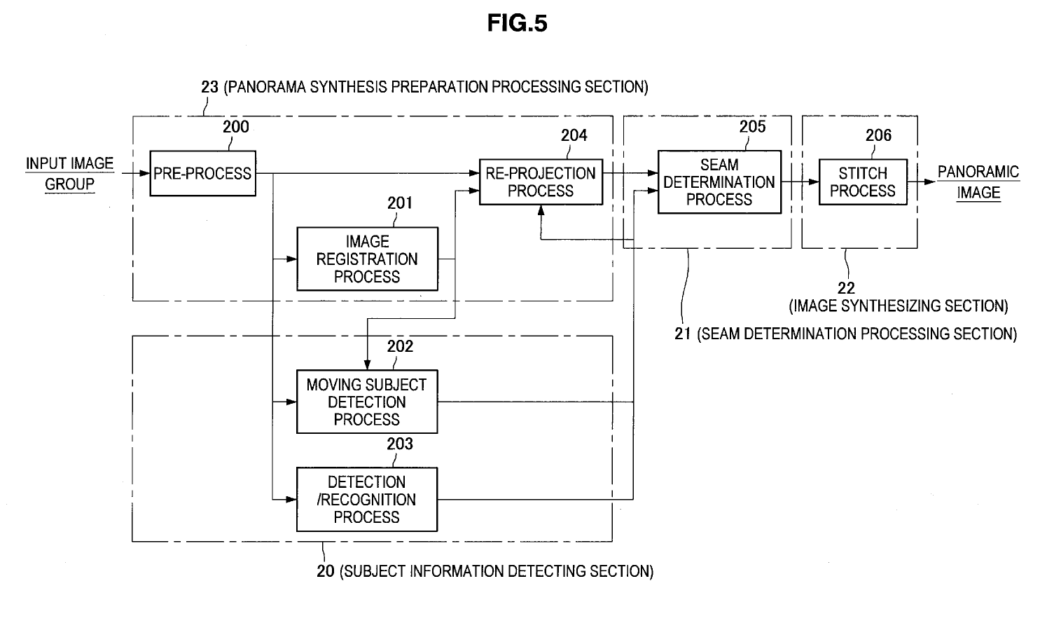

FIG. 5 shows the process executed in the image processing section 102 and the control section 103 for the panorama synthesizing process as the function configuration, and the process executed by these function configuration sites.

As shown with a chain dashed line, the function configuration includes a subject information detecting section 20, a seam determination processing section 21, an image synthesizing section 22, and a panorama synthesis preparation processing section 23.

The subject information detecting section 20 detects subject information for every frame image data in an input process of a series of n frame image data used in the generation of the panoramic image.

In this example, a moving subject detection process 202 and a detection/recognition process 203 are carried out.

The seam determination processing section 21 carries out a process (seam determination process 205) of obtaining a position of each of the m seams that becomes a joint between the adjacent frame image data for every (m+1) (m<n) frame image data group by an optimum position determination process using the subject information detected in the subject information detecting section 20, and determines m or less joints. The seam determination process 205 is sequentially performed in the input process of a series of n frame image data.

The image synthesizing session 22 carries out a stitch process 206 for generating the panoramic image data using n frame image data by synthesizing each frame image data based on the seam determined in the seam determination processing section 21.

The panorama synthesis preparation processing section 23 carries out, for example, a pre-process 200, an image registration process 201, and a re-projection process 204 as a preparation process for accurately carrying out the panorama synthesis.

The subject information detecting section 20, the seam determination processing section 21, and the image synthesizing section 22 are to be arranged to realize the characteristic operation of the present embodiment. However, the operation of the image synthesizing section 22 may be carried out by an external device, in which case, the subject information detecting section 20 and the seam determination processing section 21 are to be at least arranged in the image processing device of the present embodiment.

Each process will now be described.

The input image group, which becomes the target of the pre-process 200, is the frame image data FM#0, FM#1, FM#2, . . . sequentially obtained when the photographer is executing the panorama imaging with the imaging device 1.

First, in the panorama synthesis preparation processing section 23, the pre-process 200 for the panorama synthesizing process is carried out with respect to the image (each frame image data) imaged by the panorama imaging operation of the photographer (image here is assumed to be subjected to image processing similar to time of normal imaging).

The input image is influenced by the aberration based on the properties of the lens unit 100. In particular, the distortion aberration of the lens adversely affects the image registration process 201 and degrades the precision of alignment. The distortion aberration also causes artifact around the seam of the synthesized panoramic image, and thus the distortion aberration is corrected in the pre-process 200. The accuracy of the moving subject detection process 202 and the detection/recognition process 203 can be enhanced by correcting the distortion aberration.

The panorama synthesis preparation processing section 23 carries out the image registration process 201 on the frame image data subjected to the pre-process 200.

A plurality of frame image data is to be coordinate-transformed to a single coordinate system in the panorama synthesis, where such a single coordinate system is referred to as a panorama coordinate system.

The image registration process 201 is a process of inputting two successive frame image data, and carrying out alignment in the panorama coordinate system. The information obtained by the image registration process 201 on the two frame image data is merely the relative relationship between the two image coordinates, but the coordinate system of all the frame image data can be converted to the panorama coordinate system by selecting one of a plurality of image coordinate systems (e.g., coordinate system of a first frame image data) and fixing the same to the panorama coordinate system.

The specific process carried out in the image registration process 201 is broadly divided into the following two processes.

1. Detect local movement in image
2. Obtain global movement of entire image from the obtained local movement information

In the process of 1,

block matching
characteristic point extraction and characteristic point matching such as Harris, Hessian, SIFT, SURF, FAST are generally used to obtain a local vector of a characteristic point of the image.

In the process of 2, robust estimation methods such as

least square method

### M-Estimator

least median method (LMedS)

### RANSAC (RANdom Sample Consensus)

is used to obtain an optimum affine transform matrix and projection transform matrix (Homography) in which the relationship between the two coordinate systems is described with the local vector group obtained in the process of 1 as the input. In the present specification, such information is referred to as image registration information.

The panorama synthesis preparation processing section 23 carries out the re-projection process 204.

In the re-projection process 204, all the frame image data are subjected to the projection process on a single plane or a single curved surface such as a cylindrical surface or a spherical surface based on the image registration information obtained by the image registration process 201. At the same time, the moving subject information and the detection/recognition information are also subjected to the projection process on the same plane or the curved surface.

The re-projection process 204 of the frame image data may be carried out as the pre-stage process of the stitch process 206 or as one part of the stitch process 206 in view of optimization of the pixel process. It may also be carried out simply before the image registration process 201, for example, as one part of the pre-process 200. More simply, the process itself may not be carried out and may be handled as an approximation of a cylindrical projection process.

The subject information detecting section 20 carries out the moving subject detection process 202 and the detection/recognition process 203 on each frame image data subjected to the pre-process 200.

In the panorama synthesizing process, due to the properties of synthesizing a plurality of frame image data, if a moving subject exists in an imaging scene, the existence of the moving subject becomes a cause of image crash and degraded image quality, for example, a part of the moving subject being divided or blurred. Thus, it is preferable to detect the moving subject and then determine the seam of the panorama while avoiding the moving subject.

The moving subject detection process 202 is a process of inputting two or more successive frame image data and carrying out the detection of the moving subject. In an example of a specific process, if a difference value of the pixel of the two frame image data actually performed with the alignment by the image registration information obtained by the image registration process 201 is greater than or equal to a threshold value, the pixel is determined as the moving subject.

Alternatively, determination may be made using characteristic point information determined as an outlier at the time of the robust estimation of the image registration process 201.

In the detection/recognition process 203, position information of the face or the body of a human, an animal, and the like in the imaged frame image data is detected. Humans and animals are likely to be the moving subject, and an uncomfortable feeling in terms of visual sense is often provided compared to the other objects if the seam of the panorama is determined on the subject even if they are not moving, and hence it is preferable to determine the seam while avoiding these objects. That is, the information obtained in the detection/recognition process 203 is used to compensate for the information of the moving subject detection process 202.

The seam determination process 205 by the seam determination processing section 21 is a process of determining an appropriate seam with less crash for the panoramic image with the image data from the re-projection process 204, the image registration information from the image registration process 201, the moving subject information from the moving subject detection process 202, and the detection/recognition information from the detection/recognition process 203 as the input.

Here, the method in which the seam to obtain is limited to a line perpendicular to the sweep direction, as shown in FIG. 3A, will be described.

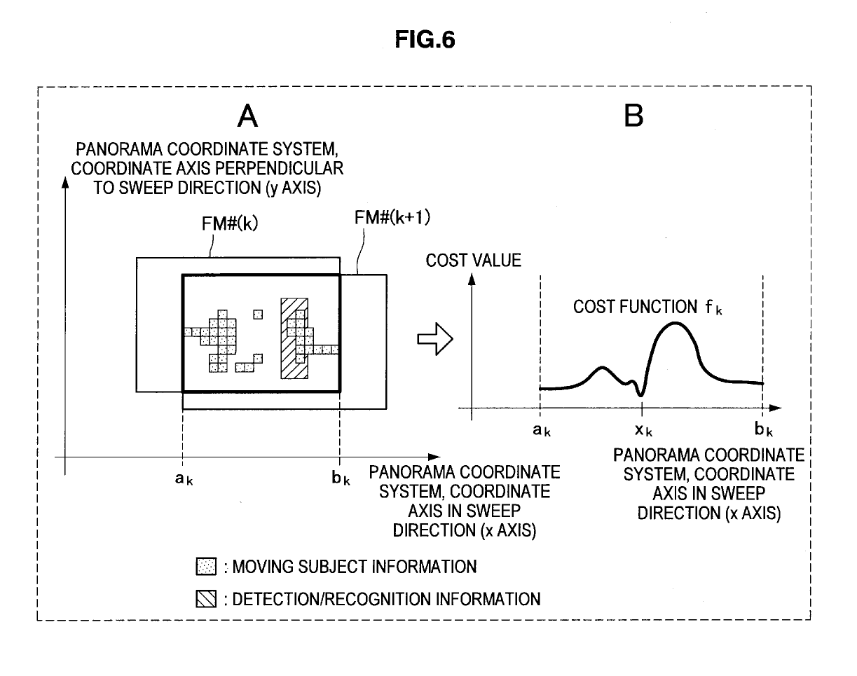

First, the definition of a cost function in an overlapping region will be described with reference to FIG. 6.

In the panorama coordinate system, the coordinate axis in the sweep direction is an x axis, and an axis perpendicular to the x axis is a y axis. It is assumed that the frame image data FM#(k) imaged at time k in a region of aₖ≦x≦bₖ and the frame image data FM#(k+1) imaged at time k+1 are overlapped, as shown in FIG. 6A.

The cost function fₖ (x) is defined as that in which the moving subject information from the moving subject detection process 202 and the detection/recognition information from the detection/recognition process 203 in the overlapping region (aₖ to bₖ) are appropriately weighted, projected in the x axis direction, and then integrated for all the information. In other words,

$${f}_{k} ( x ) = {\sum }_{i} {\sum }_{y} {mo}_{i} ( x , y ) \cdot ω {mo}_{i} ( x , y ) + {\sum }_{j} {\sum }_{y} {det}_{j} ( x , y ) \cdot ω {det}_{j} ( x , y ) \qquad [ Equation 1 ]$$

### Where

moᵢ={0, 1}: moving subject detection information (0≦i≦Nₘₒ−1)
wmoᵢ: weighting function with respect to moving subject detection information (0≦i≦Nₘₒ−1)
dstⱼ={0, 1}: detection/recognition information (0≦j≦N_{det}−1)
wdstⱼ: weighting function with respect to detection/recognition information (0≦j≦N_{det}−1)

This means that the higher the cost function value, the more the moving subject and the object such as a human body exists on the line. As described above, the seam is to be determined avoiding the objects in order to suppress the crash in the panoramic image to a minimum, and thus the x coordinate value of low cost function value is to be the position of the seam.

The moving subject detection process 202 and the detection/recognition process 203 are carried out in units of blocks normally having a few to a few dozen pixels on one side, and thus the cost function fₖ (x) is a discrete function in which x is defined with an integer value.

If, for example, the weighting function wmoᵢ with respect to the moving subject detection information is the magnitude of the movement amount in the moving subject, the region of the object with larger movement amount is less likely to become the seam.

In FIG. 6A, the relevant pixel block of the moving subject information and the detection/recognition information in the overlapping regions (aₖ to bₖ) of the frame image data FM#(k) and the FM#(k+1) is illustrated. In this case, the cost value obtained with the cost function fₖ (x) of the above (equation 1) in the range of ak≦x≦bk on the x axis, for example, is as shown in FIG. 6.

The x coordinate value (xₖ) with the lowest cost value becomes the position appropriate for the seam between the two frame image data FM#(k) and FM#(k+1).

In the seam determination process 205, an appropriate x coordinate value is calculated for the seam using the cost function.

It is to be recognized that the description made here is merely for a case viewed with the cost function between the two frame image data. In the present embodiment, the combination of m seams is to be optimized, and the seam is not merely determined between the two frame image data in the seam determination process 205. This will be specifically described later.

It is thought that the weighting function wdstⱼ with respect to the detection/recognition information may be changed by the type of detector such as face detection or human body detection, or may be reliability (score value) at the time of detection or may be changed by the detected coordinate so that the cost function value can be adjusted.

Furthermore, if the detection accuracy and the reliability of the moving subject detection process 202 and the detection/recognition process 203 differ, the weighting function of higher detection accuracy and reliability is set relatively high compared to the weighting function of lower detection accuracy and reliability to reflect the detection accuracy and the reliability on the cost function.

Thus, the seam determination processing section 21 may have the cost function fₖ (x) as a function reflecting the reliability of the subject information.

The seam determination processing section 21 may have the cost function as the cost function f′ₖ (x) reflecting a spatial condition of the image. In other words, in the above (equation 1), the cost function fₖ (x) is defined only from the moving subject information and the detection/recognition information, but a new cost function f′ₖ (x) may be defined by g(x, fₖ (x)) with respect to the cost function fₖ (x).

f′ₖ(x)=g(x,fₖ(x)) [Equation 2]

The spatial cost value that may not be represented with only the moving subject information and the detection/recognition information can be adjusted by using the new cost function f′ₖ (x).

Generally, the image quality at the periphery of the image tends to be inferior to the image quality at the center part due to the influence of aberration of the lens. Thus, the periphery of the image is desirably not used for the panoramic image as much as possible. To this end, the seam is determined around the center of the overlapping region.

The cost function f′ₖ (x) is thus defined using g(x, fₖ (x)) as shown below.

$${f}_{k}^{′} ( x ) = g ( x , {f}_{k} ( x ) ) = {t}_{0} \cdot \vert x - \frac{{b}_{k} - {a}_{k}}{2} \vert \cdot {f}_{k} ( x ) + {t}_{1} \qquad [ Equation 3 ]$$

Where t₀ and t₁ are positive constant values.

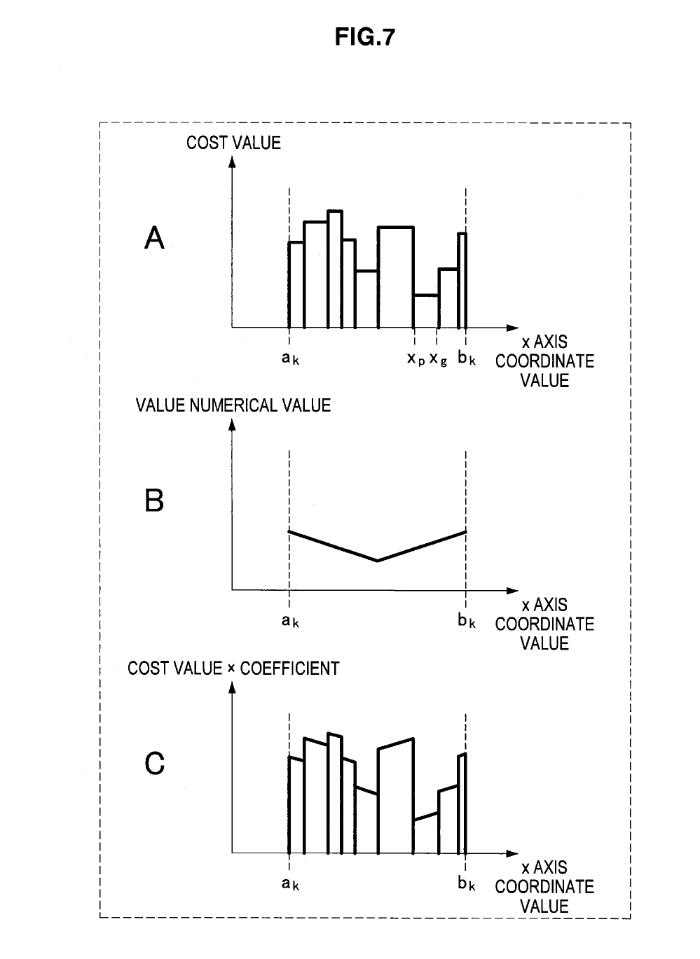

The cost function f′ₖ (x) reflecting the spatial condition will be schematically described in FIG. 7.

FIG. 7A shows the cost value obtained by the cost function fₖ (x) of the above (equation 1) in the overlapping regions (aₖ to bₖ). The cost value is shown with a curve in FIG. 6B, but is actually a bar graph as shown in FIG. 7A since the cost function fₖ(x) is a discrete function in which x is defined with an integer value.

In this case, the x coordinate value may be the seam if the coordinate value is within the range of the coordinate values xp to xq since the cost value is a minimum in the range of xp to xq of the x coordinate value in the figure. However, the seam is desirably around the center of the overlapping region as much as possible.

The term t₀•|x−(bₖ−aₖ)/2| of the (equation 3) means giving a coefficient as shown in FIG. 7B. In other words, it is a coefficient in which the closer to the center of the image, the lower the cost becomes. Here, t₁ of (equation 3) is an offset value for preventing the difference in the cost value from being eliminated by the coefficient if the cost value by the cost function fₖ (x) is 0 (portion where moving subject does not exist etc.).

The cost value obtained with the cost function f′ₖ (x) of the (equation 3) is as shown in FIG. 7C in the overlapping regions (aₖ to bₖ) as the coefficient component as shown in FIG. 7B is eventually reflected. The coordinate value xp is then selected for the seam. That is, the function is such that the seam is determined around the center of the overlapping region as much as possible.

For instance, an optimum seam taking various conditions into consideration can be selected by appropriately designing the cost function in the above manner.

Description has been made that a position where the cost function value becomes a minimum is to be obtained to determine the optimum seam in the overlapping region of the two frame image data.

A method of obtaining the combination of the optimum seam when synthesizing n (n>2) frame image data will now be described.

Considering n frame image data, the number of overlapping regions is n−1 and the cost function to be defined is also n−1.

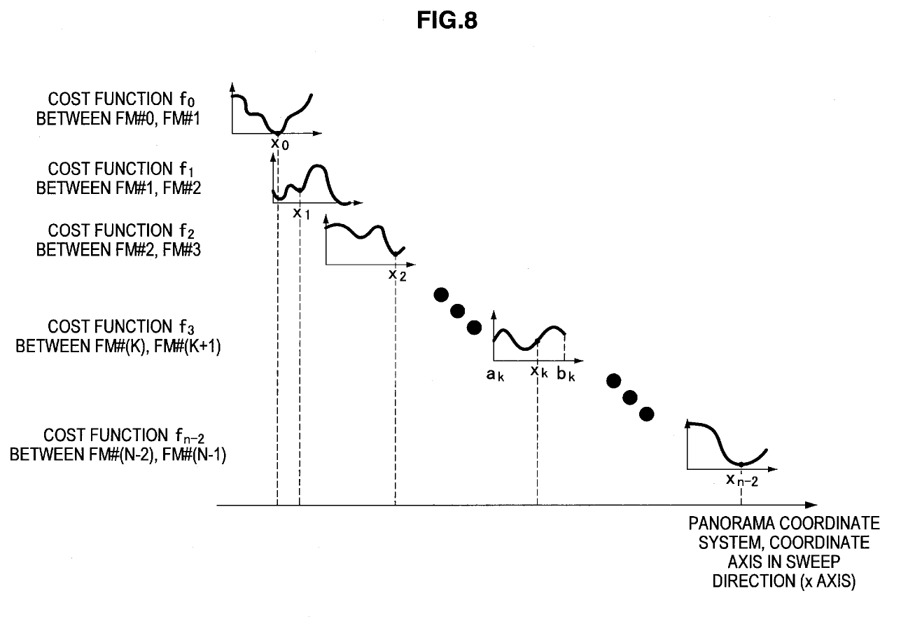

FIG. 8 shows a relationship of the cost function for the case of n frame image data. In other words, the cost function f₀ between the frame image data FM#0, FM#1, the cost function f₁ between the frame image data FM#1, FM#2, . . . and the cost function fₙ₋₂ between the frame image data FM#(n−2), FM#(n−1) are shown.

In order to panorama synthesize n frame image data and select an optimum seam as a whole, x₀, x₁ . . . xₙ₋₂, that minimize

$$F ( {x}_{0} , {x}_{1} , ⋯ , {x}_{n - 2} ) = {\sum }_{k = 0}^{n - 2} {f}_{k} ( {x}_{k} ) \qquad [ Equation 4 ]$$

are to be obtained.
Here, xₖ is an integer value satisfying below.
xₖ₋₁+α≦xₖ≦xₖ₊₁+α (restraint condition of seam)
aₖ≦xₖ≦bₖ (domain of cost function)

Here, α is a constant value defining a minimum interval of the seam.

The problem of minimizing the (equation 4) is generally called a combination optimization problem, and the following solving method is known.

### Solving Method to Obtain Exact Solution

branch and bound approach

memorization

dynamic programming

graph cut

### Solving Method to Obtain Approximate Solution

local search method (hill climbing method)

simulated annealing

taboo search

genetic algorithm

The optimization problem of (equation 4) can be solved by one of the above methods.

A case of obtaining n−2 seams among the adjacent frame image data with all n frame image data FM#0 to FM#(n−1) for carrying out panorama synthesis as a target has been described, but in the present embodiment, the process of obtaining m seams is sequentially carried out for m+1 frame image data (m<n). In this case, m seams (e.g., x₀, x₁ . . . xₘ) having the (equation 4) as a minimum are to be obtained.

The stitch process 206 is carried out in the image synthesizing section 22 of FIG. 5.

In the stitch process 206, the panoramic image is ultimately generated using the information on all the seams determined in the seam determination process 205 and each frame image data.

In this case, the adjacent frame image data may be simply connected with the seam, but the blend process is preferably carried out for image quality.

An example of the blend process will be described in FIG. 9. FIG. 9 schematically shows the synthesis of the frame image data FM#(k) and the FM#(k+1). The determined seam SMk (coordinate value xₖ) is shown with a thick line.

As shown in the figure, the blend process is carried out to reduce the unnaturalness of the joint with the region xₖ−β≦x≦xₖ+β before and after the seam as the region BL to be blended. The simple copy of pixel value or the re-sampling to the panorama coordinate system is merely carried out on the other regions x>xₖ+β, xₖ−β>x, and all the images are joined.

The blend process is carried out with the following calculation.

$${PI}_{k} ( x , y ) = \frac{β + {x}_{k} - x}{2 β} \cdot {I}_{k} ( x , y ) + \frac{β - {x}_{k} + x}{2 β} \cdot {I}_{k + 1} ( x , y ) \qquad [ Equation 5 ]$$

PIₖ(x, y): pixel value of panoramic image at panorama coordinate (x, y)
Iₖ(x, y): pixel value of frame image data FM#(k) at panorama coordinate (x, y)

The optimum seam when limited to a line perpendicular to the sweep direction is obtained with respect to the n frame image data by each process of FIG. 5 described above, and the panorama synthesized image can be ultimately obtained.

### <4. Panorama Synthesizing Process Example I>

A panorama synthesizing process example of the present embodiment executed with the function configuration shown in FIG. 6 will be described below.

In the processing example described below, the seam is sequentially determined in the input process of n frame image data when generating the panoramic image by synthesizing the n frame image data. In other words, an optimum seam is comprehensively obtained for the m seams between the adjacent images of (m+1) frame image data for every (m+1) frame image data group. 1 seams of less than or equal to m (m≧1: 1 is at least one or greater) is determined This process is repeatedly carried out in the input process of the frame image data to determine each seam.

That is, the seam determination process is sequentially advanced before the input of all n frame image data is completed. Furthermore, the image portion not to be used in the panorama synthesis is already determined in the frame image data in which the seam determination is performed. Thus, only the desired image portion is stored as the image data to use for the subsequent panorama synthesis, and the undesired portion is not stored. The image capacity to store in the processing step thus can be reduced.

Furthermore, the seam determination that takes into consideration the entire plurality of frame image data is realized by obtaining each seam with the (m+1) frame image data group.

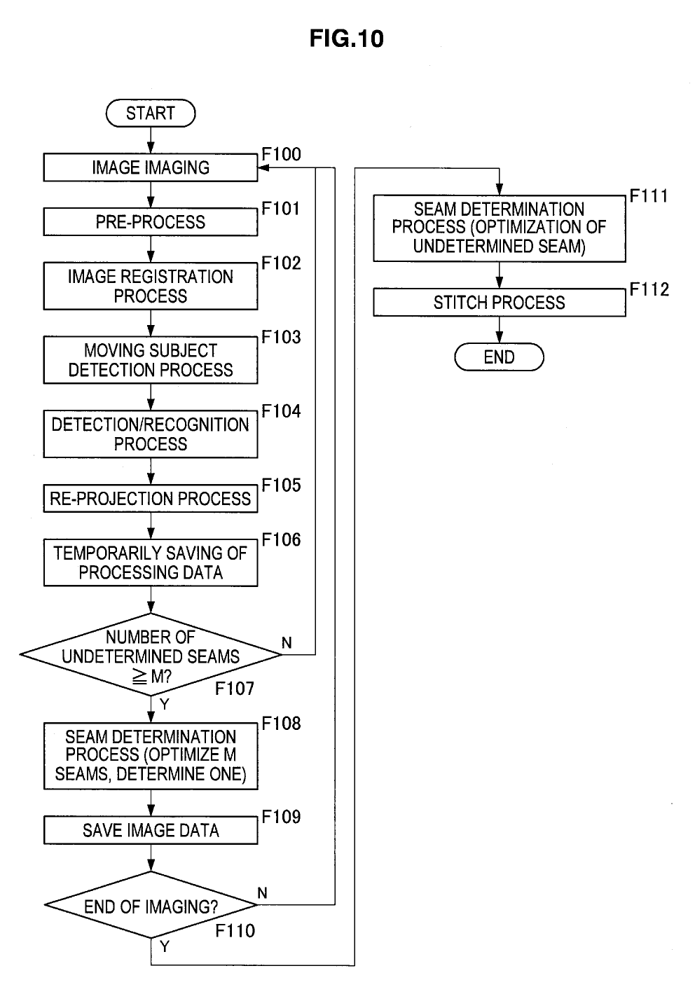

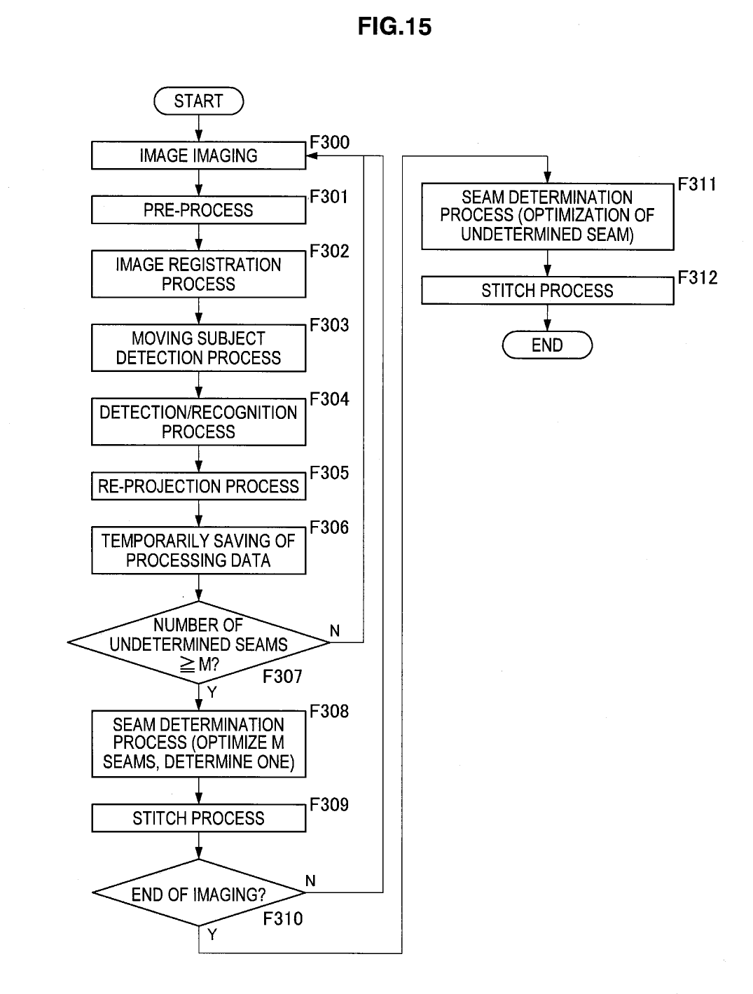

First, the panorama synthesizing process example I will be described with FIG. 10. FIG. 10 (and FIG. 14 and FIG. 15 to be described later) is a flowchart in which a few control elements are added to the processing elements executed in each function configuration mainly shown in FIG. 5. In the process of FIG. 10, the corresponding process of FIG. 5 is merely additionally described in the following description for the processes of the same name as the processing elements of FIG. 5 and redundant specific description is avoided.

The image imaging of step F100 refers to a process of imaging one still image in a panorama imaging mode, and retrieving the same as one frame image data in the imaging device 1. In other words, an imaging signal obtained in an imaging element 101 is subjected to an imaging signal processing by the image processing section 102 according to the control of the control section 103 to become one frame image data.

The frame image data may be provided to the panorama synthesizing process in the image processing section 102 as is (processes after step F101 by each section of FIG. 5), or may be once retrieved to the memory section 105 and then provided to the panorama synthesizing process in the image processing section 102 as one frame image data.

In each section of FIG. 5 (panorama synthesis preparation processing section 23, subject information detecting section 20, seam determination processing section 21, image synthesizing section 22) realized by the image processing section 102 and the control section 103, the processes after step F101 are carried out according to the input of the frame image data based on step F100.

In step F101, the panorama synthesis preparation processing section 23 carries out a pre-process (pre-process 200 of FIG. 5).

In step F102, the panorama synthesis preparation processing section 23 carries out an image registration process (image registration process 201 of FIG. 5).

In step F103, the subject information detecting section 20 carries out a moving subject detection process (moving subject detection process 202 of FIG. 5).

In step F104, the subject information detecting section 20 carries out a detection/recognition process (detection/recognition process 203 of FIG. 5).

In step F105, the panorama synthesis preparation processing section 23 carries out a re-projection process (re-projection process 204 of FIG. 5).

In step F106, the processing data up to step F105 are temporarily saved in the memory section 105. In other words, the processing data used in the panorama synthesis such as the pixel information of the image, the image registration information, the moving subject detection information, the detection/recognition information and the like are temporarily saved. The frame image data itself is also temporarily saved in the memory section 105 if not saved at this point.

This is a process in which the panorama synthesis preparation processing section 23 and the subject information detecting section 20 temporarily store various types of data and image to provide to the seam determination processing section 21.

Thereafter, the processes of steps F101 to F106 are repeated for every input of the frame image data obtained in step F100 until the number of undetermined seams becomes greater than or equal to m in step F107.

The seam determination processing section 205 executes the process according to the determination of step F107.

In other words, if determined that the undetermined seams are greater than or equal to m in step F107, that is, if the temporarily saved frame image data in which the seam is not determined is m+1, the seam determination processing section 21 carries out optimization of (equation 4) with the method described above on the m seams in step F108. The 1 (1≦m) seams are determined in order from the start of imaging of the m solutions of the optimization result.

Furthermore, in step F109, the seam determination processing section 21 saves the frame image data in which the seam is determined in the memory section 105. In this case, the pixel data portion that eventually does not contribute to the panoramic image may not be saved and only the desired portion may be saved since the seam is determined Neither the moving subject detection information nor the detection/recognition information is necessary to be saved. The data related to the frame image data in which the seam is determined as the data temporarily saved in step F106 may be discarded at this point.

The processes of steps F100 to F109 are repeated until the determination on end of imaging is made in step F110. The end of imaging in step F110 is a process in which the control section 103 carries out a determination on the end of imaging in the panorama imaging mode. The conditions for the end of imaging are,

photographer releases shutter button
imaging of defined field angle is finished
defined number of imaging is exceeded
hand jiggle amount in defined sweep direction and perpendicular direction is exceeded
other errors

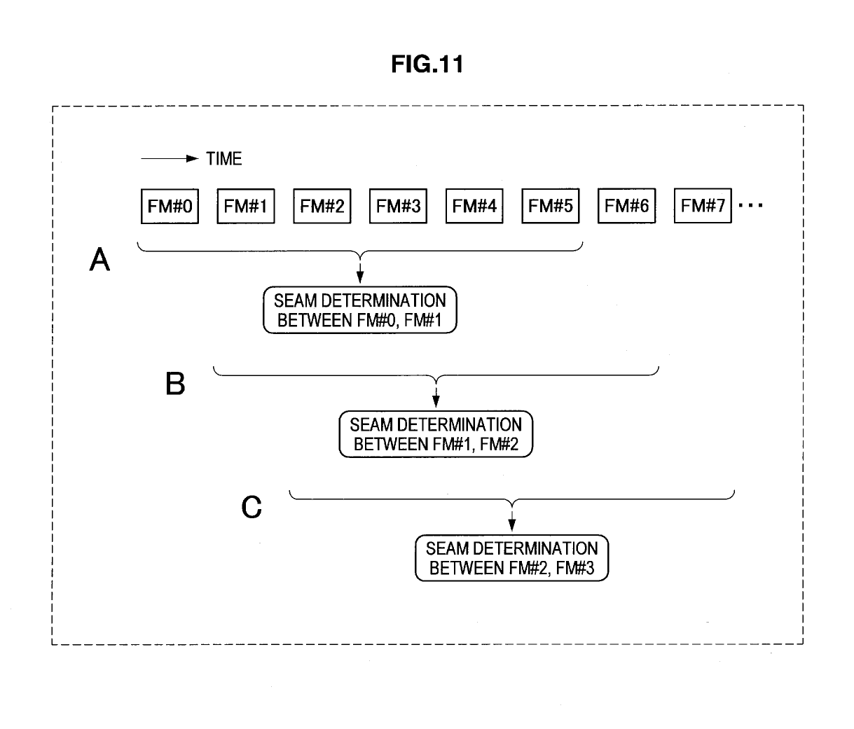

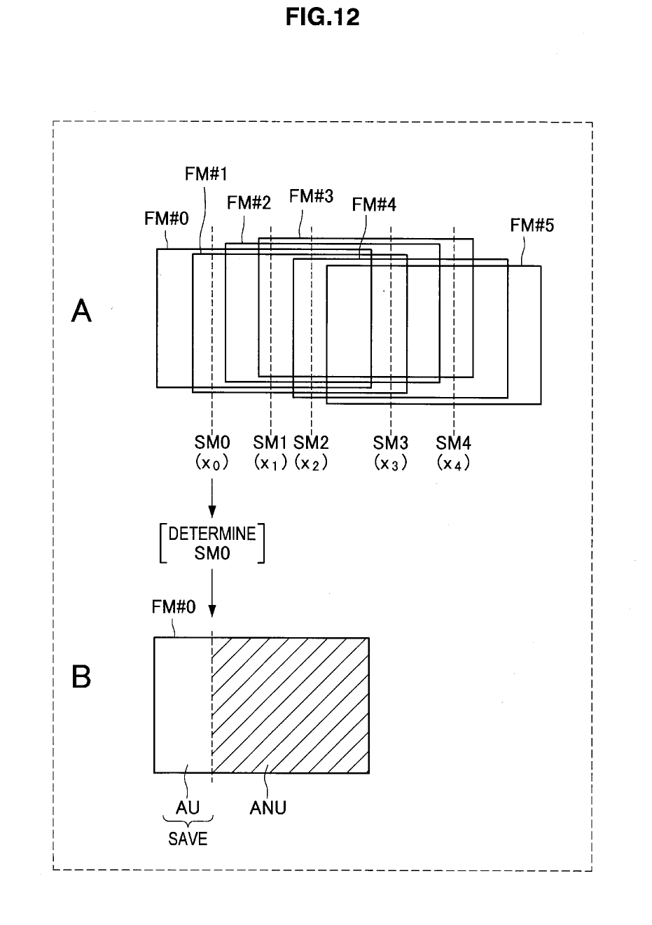

The processes of steps F107, F108, and F109 will be described in FIG. 11 and FIG. 12.

By way of example, it is assumed m=5 of criterion for the number of undetermined seams in step F107. Also, it is assumed that the number of seams to determine in step F108 is 1=1.

FIG. 11 shows the frame image data FM#0, FM#1, . . . to be sequentially input.

During the period after the first frame image data FM#0 is input in step F100 until the fifth frame image data FM#4 is input, the number of undetermined seams is four or less, and thus the steps F101 to F106 are repeated for every input of each frame image data (FM#0 to FM#4).

At the point when the sixth (i.e., m+1) frame image data FM#5 is input and the processes up to step F106 are carried out, the number of undetermined seams is five in step F107, and thus the number of undetermined seams m is obtained, and the process proceeds to step F108.

In this case, the seam determination processing section 21 obtains the position of each of m joints, which is the joint between the adjacent frame image data, by an optimum position determination process using the subject information detected in the moving subject detection process 202 (step F103) and the detection/recognition process 203 (step F104) for the respective frame image data with respect to (m+1) frame image data group (i.e., frame image data FM#0 to FM#5) in step F108. Then, 1 (e.g., one) joint is determined

The optimum position determination process in this case is a process of optimizing five seams for between the frame image data FM#0 and FM#1, between FM#1 and FM#2, between FM#2 and FM#3, between FM#3 and FM#4, and between FM#4 and FM#5. In other words, the five seams obtained with the cost function fₖ of the (equation 1) (or f′ₖ of the (equation 3) for each adjacent frame image data are optimized by the (equation 4).

1, for example, one seam early in order among the five optimized seams is determined

This is schematically shown in FIG. 12A. FIG. 12A shows a state in which the frame image data FM#0 to FM#5 are overlapped on the panorama coordinate, where the x coordinate values x₀ to x₄ serving as the seams SM0 to SM4 between the adjacent frame image data are optimized by the (equation 4).

One seam SM0 at the head is determined as the x coordinate value x₀.

The frame image data in which the seam is determined is saved in step F109, but in this case, one part of the frame image data FM#0 is saved as shown in FIG. 12B. That is, since the seam SM0 is determined, the image region of the frame image data FM#0 is divided into a region AU to use for the panoramic image and a region ANU not to use for the panoramic image. In step F109, only the region AU is to be saved.

The image data of the entire frame image data FM#0 temporarily saved in step F106 and the related data of the frame image data FM#0 used for the seam determination are erased at this point.

For instance, in the first steps F108 and F109, the optimization of five seams is carried out with the frame image data FM#0 to FM#5 as the target, as shown in FIG. 11A, one seam, that is, the seam SM#0 between the frame image data FM#0 and FM#1 is determined, and the desired image region is saved.

Thereafter, the following frame image data FM#6 is input, and steps F101 to F106 are carried out.

In the first step F108, one seam SM0 is simply determined, and hence the number of undetermined seams again becomes five in step F107 after the frame image data FM#6 is input.

As shown in FIG. 11B, the optimization of the five seams is now carried out with the frame image data FM#1 to FM#6 as the target in step F108, and one seam, that is, the seam SM#1 between the frame image data FM#1 and FM#2 is determined The image region desired for the frame image data FM#1 is saved in step F109.

Similarly, after the input of the frame image data FM#7, the optimization of the five seams is carried out with the frame image data FM#2 to FM#7 as the target in step F108, as shown in FIG. 11C, and one seam, that is, the seam SM#2 between the frame image data FM#2 and FM#3 is determined The image region desired for the frame image data FM#2 is saved in step F109.

Therefore, the seam determination processing section 21 sequentially executes the process of obtaining each of m seams to become the joint between the adjacent frame image data through the optimum position determination process for every (m+1) frame image data group and determining 1 seam of less than or equal to m in the input process of the frame image data.

Here, one seam is determined with 1=1, but if m=5, the number of seams to determine 1 may be two to five.

The processes of steps F100 to F109 of FIG. 10 are thereafter continued until an end of imaging is determined in step F110.

When imaging is finished, the seam determination processing section 21 determines the seam undetermined at the relevant point as in the above in step F111. As a result, all the seams SM0 to SM(n−2) as shown in FIG. 3A are determined in relation to n frame image data FM#0 to FM#(n−1) in all.

In step F112, the image synthesizing section 22 executes the stitch process 206. In other words, each frame image data is joined at each seam SM0 to SM(n−2). The blend process is also carried out when joining.

One panoramic image data as shown in FIG. 4 is thereby generated.

According to the panorama synthesizing process example I of FIG. 10, the seam determination process 205 is sequentially carried out without waiting for the end of imaging of all frame image data.

In saving all image data, only image data as much as m+1 frame image data is a maximum in temporarily saving in step F106. With respect to the frame image data for n-m−1, only the pixel data of a portion contributing to the panoramic image is to be saved, and the desired memory capacity is greatly reduced.

For instance, in the case of the normal panorama synthesizing process, when not only simply determining the seam between the two frame image data with the cost function but also optimizing each seam in view of all frame image data, each seam is to be determined after all the n frame image data are input. Then, n frame image data is to be saved until the imaging of all images is finished in the processing step, and hence the memory capacity for temporary saving becomes large. In particular, the memory capacity for saving n frame image data becomes enormous when the data size of one frame image data becomes large with advancement in higher resolution. It may not be achievable unless measures such as lowering the resolution of the imaged image or reducing the number of imaged image are taken in the incorporating device where the usage efficiency of the memory is degraded and the memory restriction is great.

In the case of the present embodiment, the desired memory capacity is greatly reduced as described above, and thus a high image quality panorama synthesis can be generated without lowering the resolution or reducing the number of imaged image even in the imaging device 1 with great memory restriction.

In other words, if the panorama synthesizing process example I is carried out for the present embodiment, the seam determination is gradually carried out from a small number of image groups (m+1; e.g., few) in which processes such as imaging, alignment, various types of detection processes and the like are finished, and is repeated to gradually determine the seam of the entire panoramic image, so that the image data, which is no longer desired, and the accompanying information can be erased and the memory efficiency can be greatly enhanced. In particular, in an incorporating device in which the mounting memory is limited, the panorama synthesis at high resolution and wide field angle, which is not possible in the related art, is enabled.

The entire processing time until the completion of the panorama synthesis can be reduced by sequentially carrying out the seam determination process even during the imaging.

However, as the seam is not optimized with all n frame image data as the target after retrieving all frame image data, the panorama image quality may possibly lower in that regard.

The seam to be sequentially determined is thus preferably optimized as much as possible even when viewed from the entire image with the following devisal.

In other words, when optimizing the seam in step F108, among m seams, the optimization is carried out at a position closer to a direction opposite to the sweep direction within a domain aₖ≦x≦bₖ of the cost function, that is, a position of small x coordinate in FIG. 8 as the seam is of the temporally-early frame image data. Thus, lowering in performance of the panorama image quality can be reduced by leaving the degree of freedom with respect to the seam to carry out the optimization the next time and thereafter.

In one method therefor, the seam determination processing section 21 assumes the cost function for obtaining the cost function value as the function reflecting the frame order in the (m+1) frame image data group.

Alternatively, in another method, the seam determination processing section 21 changes the restraint condition in obtaining the seam between the adjacent frame image data based on the cost function value according to the frame order in the (m+1) frame image data group in the (m+1) frame image data group. For instance, the setting of the joint set range (i.e., overlapping region aₖ to bₖ) in which the subject is overlapped between the adjacent frame image data is changed for the restraint condition.

First, a method in which the cost function is made as a function reflecting the frame order will be described.

In this case, the cost function f′hd k(x) (or fₖ(x)) is to be adjusted.

For instance, an adjusted cost function f″ₖ (x) is obtained from the existing cost function f′ₖ(x) with the following equation.

f″ₖ(x)=f′ₖ(x)+t₂·k(x−aₖ) [Equation 6]

Where t₂ is a positive constant value.

In this case, adjustment is made such that the cost value lowers at the x coordinate on the left side (aₖ side) in the range of the overlapping region aₖ to bₖ by the term t₂·k(x−aₖ), and the degree of cost value becomes greater as the frame image data is temporally-early.

Therefore, the seam tends to be optimized at the position of small x coordinate in the domain aₖ≦x≦bₖ of the cost function as the seam is of the temporally-early frame of the m seams.

When changing the restraint condition according to the frame order,

the domain aₖ≦x≦bₖ of the cost function is to become aₖ≦x≦bₖ−t₃·k where −t₃ is a positive constant value.

Accordingly, the domain of the cost function becomes a narrow range on the left side (aₖ side) as the frame image data is temporally-early.

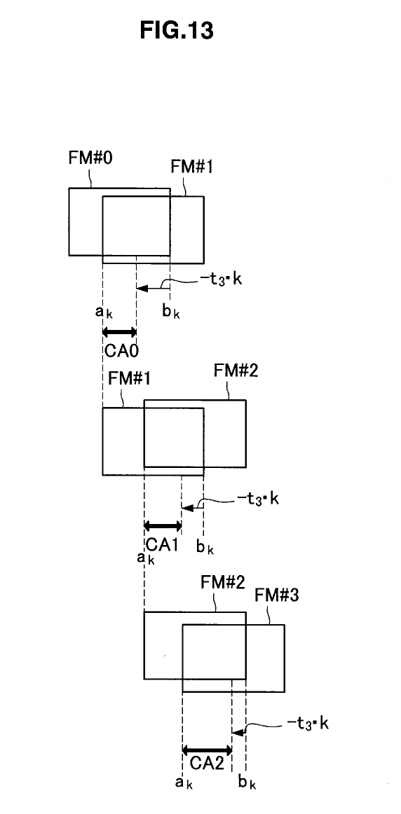

As schematically shown in FIG. 13, the domain of the cost function between the frame image data FM#0 and FM#1 becomes a range CA0, the domain of the cost function between the frame image data FM#1 and FM#2 becomes a range CA1, and the domain of the cost function between the frame image data FM#2 and FM#3 becomes a range CA2. Consequently, the seam tends to be easily optimized at the position of small x coordinate as the seam is of temporally-early frame.

As described above, optimization with less degradation in performance by the m+1 frame image data group can be realized with the optimization algorithm same as at the time of the seam optimization by all n imaged images by carrying out the adjustment of the cost function or the adjustment of the restricting condition, or both.

Therefore, a great reduction in the memory usage amount can be realized with lowering in performance of the panorama image quality suppressed as much as possible by the process of FIG. 10.

### <5. Panorama Synthesizing Example II>

A panorama synthesizing process example II of the embodiment will be described with FIG. 14.

In the panorama synthesizing process example II of FIG. 14, the processes of the panorama synthesis preparation processing section 23 and the subject information detecting section 20 of FIG. 5, and the processes of the seam determination processing section 21 and the image synthesizing section 22 are parallel processes. The substantial processing content is similar to the processing content of FIG. 10.

FIG. 14A shows processes executed in the panorama synthesis preparation processing section 23 and the subject information detecting section 20 for each frame image data input in step F200 by imaging.

In other words, the pre-process (step F201) by the panorama synthesis preparation processing section 23, the image registration process (step F202), the moving subject detection process (step F203) by the subject information detecting section 20, the detection/recognition process (step F204), and the re-projection process (step F205) by the panorama synthesis preparation processing section 23 are carried out for every input of the frame image data. The frame image data and the related information are temporarily stored in the memory section 105.

The above processes are similar to those in steps F100 to F106 of FIG. 10.

The processes are repeated until the end of imaging in step F207 is determined

FIG. 14B shows the processes of the seam determination processing section 21 and the image synthesizing section 22.

The seam determination processing section 21 checks the number of undetermined seams in step F220. In other words, the number of undetermined seams by the frame image data group temporarily stored in the memory section 105 in the process of FIG. 14A is checked. If the number of undetermined seams is ≧m, the seam determination process is carried out in step F221 and the image data saving process is carried out in step F222. These are similar to steps F107, F108, F109 of FIG. 10.

The processes of FIG. 14B repeat steps F220 to F222 until the end of imaging in the process of FIG. 14A, that is, until completion of the input of new frame image data.

When the input of the new frame image data is finished, the process proceeds from step F223 to F224 where the seam determination processing section 21 determines the seam undetermined at the point as described above. As a result, all seams SM0 to SM(n−2) as shown in FIG. 3A are determined with respect to n frame image data FM#0 to FM#(n−1) in total.

In step F225, the image synthesizing section 22 carries out the stitch process of generating the panoramic image data using all the determined seams.

Effects similar to those in the case of the panorama synthesizing process example I of FIG. 10 are obtained by executing the processes of FIG. 14A and FIG. 14B in parallel.

### <6. Panorama Synthesizing Process Example III>

A panorama synthesizing process example III of the embodiment will be described with FIG. 15.

In the panorama synthesizing process example III, not only the seam determination process but also processes up to the stitch process on the image in which the seam is determined are carried out without waiting for the end of imaging of all images.

In FIG. 15, steps F300 to F308 are similar to steps F100 to F108 of FIG. 10, and thus the repetitive description will be avoided.

In the case of FIG. 15, the image synthesizing section 22 carries out the stitch process in step F309 every time the seam determination processing section 21 determines 1 seams in step F308. This process is repeated until the end of imaging.

After the end of imaging in step F310 is determined, the seam determination processing section 21 determines the remaining seams in step F311, and the image synthesizing section 22 carries out the stitch process based on the remaining determined seams in step F312 to complete the panoramic image data.

The processes of FIG. 15 also have effects similar to the processes of FIG. 10. In addition, in the case of the processes of FIG. 15, the storage of the image data of the pixel portion to be used for the panoramic image of n-m−1 frame image data, which is desired in the process of FIG. 10, is no longer desired, so that the memory amount can be reduced.

Furthermore, the entire panorama synthesizing process time can be further reduced since even the stitch process is started during the image imaging.

### <7. Program>

The program of the embodiment is a program for causing a calculation processing unit to sequentially execute a process of detecting subject information for each frame image data, and a process of obtaining each of m seams to become a joint between the adjacent frame image data through an optimum position determination process using the subject information for every (m+1) frame image data group and determining 1 seams of less than or equal to m in an input process of a series of n frame image data to be used in generating the panoramic image.

In other words, it is a program for causing the image processing section 102 and the control section 103 to execute the above processes of FIG. 10, FIG. 14, or FIG. 15.

The program of the embodiment may be stored in advance in the imaging device 1, an HDD (Hard Disk Drive) serving as a recording medium incorporated in other information processing device or an image processing device, a ROM in a microcomputer including a CPU, and the like.

Alternatively, the program may be temporarily or permanently stored (recorded) in a removable recording medium such as a flexible disc, a CD-ROM (Compact Disc Read Only Memory), an MO (Magnet Optical) disc, a DVD (Digital Versatile Disc), a magnetic disc, or a semiconductor memory.

Such removable recording medium can be provided as a so-called package software. For instance, if provided by the CD=ROM, the program can be installed in the information processing device such as the personal computer to execute the panorama synthesizing process described above.

Other than being installed from the removable recording medium, the program can be downloaded from a download site through a network such as the LAN (Local Area Network) or the Internet.

The general purpose personal computer may serve as the image processing device according to the embodiment of the present disclosure by installing the program.

According to the program or the recording medium recorded with the program, the recording image processing device that realizes the effects described above can easily be realized.

### <8. Variant>

The embodiments have been described above, but various variants can be considered for the image processing device according to the embodiment of the present disclosure.

The image processing device according to the embodiment of the present disclosure may be mounted on an information processing device such as a personal computer or a PDA (Personal Digital Assistant) other than the imaging device 1 described above. It is also useful to mount the image processing device according to the embodiment of the present disclosure on a portable telephone, game machine, or a video device that has the imaging function, as well as a portable telephone, game machine, a video device, or an information processing device that does not have the imaging function but has a function of inputting the frame image data.

For instance, in the case of a device that does not have the imaging function, the processes of FIG. 10, FIG. 14, or FIG. 15 are carried out with respect to a series of input frame image data to realize the panorama synthesizing process having the effects described above.

Considering a device in which the frame image data is input with the subject information, the processes of FIG. 14B are at least carried out.

Furthermore, an image processing device for carrying out the processes excluding step F112 of FIG. 10 and step F224 of FIG. 14 is also considered.

In other words, it is a device for carrying out the processes up to the seam determination with respect to a series of frame image data obtained by imaging or a series of frame image data provided from an external device. The panorama synthesizing process can be carried out in the external device by outputting the information of the determined seam to the external device.

An example of the case of using a linear seam shown in FIG. 3A has been described in the embodiment, but the processes of FIG. 10, FIG. 14, and FIG. 15 of the present disclosure can also be applied to the case of setting a non-linear seam as shown in FIG. 3B.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing device including:

a subject information detecting section for detecting subject information for frame image data in an input process of a series of n frame image data used to generate a panoramic image; and

a seam determination processing section for sequentially carrying out, in the input process, a process of obtaining a position of each of m joints to become a joint between adjacent frame image data through an optimum position determination process using the subject information detected by the subject information detecting section for every (m+1) (m<n) frame image data group and determining m or less joints.

(2)

The image processing device according to (1), further including an image synthesizing section for generating panoramic image data using the n frame image data by synthesizing each frame image data based on the joint determined by the seam determination processing section.

(3)

The image processing device according to (2),

wherein the image synthesizing section generates the panoramic image data using the n frame image data after (n−1) joints are determined by the seam determination processing section.

(4)

The image processing device according to (2),

wherein the image synthesizing section carries out synthesis of the plurality of frame image data based on the determined joint every time the seam determination processing section determines one or more joints in the input process.

(5)

The image processing device according to any one of (1) to (4),

wherein the seam determination processing section calculates a cost function value reflecting subject information from the subject information, and carries out a calculation for optimizing the cost function value to obtain the position of each of m joints in the optimum position determination process.

(6)

The image processing device according to (5),

wherein the calculation for optimizing the cost function is a calculation of obtaining each of m joints in which a sum of the cost function value of each joint becomes a minimum value for each of m joints, which is a joint position selected based on the cost function value within a joint setting range in which a subject is overlapped between the adjacent frame image data.

(7)

The image processing device according to (5) or (6),

wherein the seam determination processing section assumes a cost function for obtaining the cost function value as a function reflecting a spatial condition of an image.

(8)

The image processing device according to any one of (5) to (7),

wherein the seam determination processing section assumes a cost function for obtaining the cost function value as a function reflecting a reliability of the subject information.

(9)

The image processing device according to any one of (5) to (8),

wherein the seam determination processing section assumes a cost function for obtaining the cost function value as a function reflecting a frame order in the (m+1) frame image data group.

(10)

The image processing device according to any one of (5) to (9),

wherein the seam determination processing section changes a restraint condition in obtaining the joint between the adjacent frame image data based on the cost function value in accordance with a frame order in the (m+1) frame image data group in the (m+1) frame image data group.

(11)

The image processing device according to (10),

wherein the restraint condition is a setting of a joint setting range in which a subject is overlapped between the adjacent frame image data.

(12)

The image processing device according to any one of (1) to (11),

wherein the subject information detecting section carries out a moving subject detection for the detection of the subject information.

(13)

The image processing device according to any one of (1) to (12),

wherein the subject information detecting section carries out a face detection for the detection of the subject information.

(14)

The image processing device according to any one of (1) to (13),

wherein the subject information detecting section carries out a human body detection for the detection of the subject information.

The present disclosure contains subject matter related to that disclosed in Japanese Priority Patent Application JP 2011-087893 filed in the Japan Patent Office on Apr. 12, 2011, the entire content of which is hereby incorporated by reference.

What is claimed is:

1. An image processing device comprising:
a subject information detecting section for detecting subject information for frame image data in an input process of a series of n frame image data used to generate a panoramic image; and
a seam determination processing section for sequentially carrying out, in the input process, a process of obtaining a position of each of m joints to become a joint between adjacent frame image data through an optimum position determination process using the subject information detected by the subject information detecting section for every (m+1) (m<n) frame image data group and determining m or less joints.

2. The image processing device according to claim 1, further comprising an image synthesizing section for generating panoramic image data using the n frame image data by synthesizing each frame image data based on the joint determined by the seam determination processing section.

3. The image processing device according to claim 2,
wherein the image synthesizing section generates the panoramic image data using the n frame image data after (n−1) joints are determined by the seam determination processing section.

4. The image processing device according to claim 2,
wherein the image synthesizing section carries out synthesis of the plurality of frame image data based on the determined joint every time the seam determination processing section determines one or more joints in the input process.

5. The image processing device according to claim 1,
wherein the seam determination processing section calculates a cost function value reflecting subject information from the subject information, and carries out a calculation for optimizing the cost function value to obtain the position of each of m joints in the optimum position determination process.

6. The image processing device according to claim 5,
wherein the calculation for optimizing the cost function is a calculation of obtaining each of m joints in which a sum of the cost function value of each joint becomes a minimum value for each of m joints, which is a joint position selected based on the cost function value within a joint setting range in which a subject is overlapped between the adjacent frame image data.

7. The image processing device according to claim 5,
wherein the seam determination processing section assumes a cost function for obtaining the cost function value as a function reflecting a spatial condition of an image.

8. The image processing device according to claim 5,
wherein the seam determination processing section assumes a cost function for obtaining the cost function value as a function reflecting a reliability of the subject information.

9. The image processing device according to claim 5,
wherein the seam determination processing section assumes a cost function for obtaining the cost function value as a function reflecting a frame order in the (m+1) frame image data group.

10. The image processing device according to claim 5,
wherein the seam determination processing section changes a restraint condition in obtaining the joint between the adjacent frame image data based on the cost function value in accordance with a frame order in the (m+1) frame image data group in the (m+1) frame image data group.

11. The image processing device according to claim 10,
wherein the restraint condition is a setting of a joint setting range in which a subject is overlapped between the adjacent frame image data.

12. The image processing device according to claim 1,
wherein the subject information detecting section carries out a moving subject detection for the detection of the subject information.

13. The image processing device according to claim 1,
wherein the subject information detecting section carries out a face detection for the detection of the subject information.

14. The image processing device according to claim 1,
wherein the subject information detecting section carries out a human body detection for the detection of the subject information.

15. An image processing method comprising:
sequentially carrying out, in an input process of a series of n (m<n) frame image data used to generate a panoramic image,
detecting subject information for frame image data; and
obtaining a position of each of m joints to become a joint between adjacent frame image data through an optimum position determination process using the subject information detected by a subject information detecting section for every (m+1) frame image data group and determining m or less joints.

16. A program for causing a calculation processing unit to sequentially execute, in an input process of a series of n (m<n) frame image data used to generate a panoramic image, processes of:
detecting subject information for frame image data; and
obtaining a position of each of m joints to become a joint between adjacent frame image data through an optimum position determination process using the subject information detected by a subject information detecting section for every (m+1) frame image data group and determining m or less joints.
